(19) United States
(12) Patent Application Publication
(10) Pub. No.: US 2012/0315607 A1
(43) Pub. Date: Dec. 13, 2012

(54) APPARATUS AND METHOD FOR PROVIDING AN INTERFACE IN A DEVICE WITH TOUCH SCREEN

(75) Inventors: Hang-Sik Shin, Yongin-si (KR); Jung-Hoon Park, Seoul (KR); Sung-Joo Ahn, Seoul (KR)

(73) Assignee: Samsung Electronics Co., Ltd., Suwon-si (KR)

(21) Appl. No.: 13/492,705

(22) Filed: Jun. 8, 2012

(30) Foreign Application Priority Data
Jun. 9, 2011 (KR) 10-2011-0055691

(51) Int. Cl. G09B 21/00; G06F 3/041

(52) U.S. Cl. 434/114

(57) ABSTRACT

In one embodiment, an apparatus and method for providing an interface in a device with a touch screen. The method includes displaying on a screen, a directory including a plurality of names and phone numbers corresponding to the names. When a touch event takes place, focusing a region in screen where the touch event occurs, and converting a name and phone number in the focusing region into Braille data and transmitting the Braille data to a Braille display through the interface.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Jun. 9, 2011 and assigned Serial No. 10-2011-0055691, the contents of which are herein incorporated by reference.

### TECHNICAL FIELD OF THE INVENTION

The present invention generally relates to devices with touch screens, and more particularly, to an interface for improving the accessibility of the disabled in a device with a touch screen.

### BACKGROUND OF THE INVENTION

Along with the growth of a multimedia information service has been a demand for communication terminals capable of supporting multimedia information services for the disabled. Particularly, communication terminals for the visually challenged user are often able to apply a user interface for efficiently supporting an auditory sense, a tactual sense and the like, that supplements its user's restricted ability.

Presently, conventional communication terminals have been limited to the non-disabled. For example, the interface of most conventional communication terminals has been accomplished through a touch screen, so there is a problem that a visually challenged user experiences difficulty in using the terminal. Also, the disabled user may desire to use the terminal through interacting with the terminal, but a visually challenged user may have difficulty due to the deficiency of the interface between devices.

### SUMMARY OF THE INVENTION

To address the above-discussed deficiencies of the prior art, it is a primary object to provide at least the advantages below. Accordingly, one aspect of the present invention is to provide an interface for improving the accessibility of the disabled in a device with a touch screen.

The above aspects are achieved by providing an apparatus and method for providing an interface in a device with a touch screen.

According to one aspect of the present invention, a method for providing an interface in a device with a touch screen includes displaying on a screen, a directory including a plurality of names and phone numbers corresponding to the names, in a case where a touch event takes place, focusing a region within a screen in which the touch event occurs, and converting a name and phone number within the focused region into Braille data and transmitting the Braille data to a Braille display through an interface.

According to another aspect of the present invention, a method for providing an interface in a device with a touch screen includes displaying on a screen, a text message list composed of a plurality of phone numbers and at least a portion of a text message content corresponding to the phone numbers, such that, when a touch event occurs, focusing a region in the touch screen where the touch event occurs, and converting a phone number and the text message content in the focusing region into Braille data and transmitting the Braille data to a Braille display through the interface.

According to another aspect of the present invention, a method for providing an interface in a device with a touch screen includes, when a call request signal is received, extracting sender information from the received call request signal, and converting the extracted sender information into Braille data and transmitting the Braille data to a Braille display through the interface.

According to another aspect of the present invention, a method for providing an interface in a device with a touch screen includes displaying on a screen, an application list including a plurality of application names and icons such that, when a touch event occurs, focusing a region within the screen where the touch event occurs, determining if the focused region is located in a first region of the screen, when the focusing region is located in the first region of the touch screen, zooming in and displaying an application name and icon within the focused region in a second region of the screen, and in a case where the focused region is located in the second region of the screen, zooming in and displaying the application name and icon within the focused region in the first region of the screen.

According to still another aspect of the present invention, a method for providing an interface in a device with a touch screen includes dividing a screen region into an (n×m) array of regions, mapping an application name to each of the divided regions, setting one region as a basic position such that when a touch event occurs, recognizing a position of occurrence of the touch event as a basic position on the (n×m) array of regions, when a position is changed in a state where the touch event is maintained, changing the touch event position according to the position change based on the (n×m) array of regions, and when a drop event occurs, executing an application of an application name mapped to a position of occurrence of the drop event.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example device with a touch screen, a Braille display, and an interface according to the present invention;

FIG. 2 illustrates an example of an incoming number display method for the visually challenged user in a device with a touch screen according to a first exemplary embodiment of the present invention;

FIG. 3 illustrates an incoming number display method for the visually challenged user in a device with a touch screen according to an embodiment of the present invention;

FIG. 4 illustrates an example of a directory search and call request method for the visually challenged user in a device with a touch screen according to another exemplary embodiment of the present invention;

FIGS. 5A and 5B illustrate a directory search and call request method for the visually challenged user in a device with a touch screen according to another embodiment of the present invention;

FIG. 6 illustrates an example of a text message search and call request method for the visually challenged user in a device with a touch screen according to another embodiment of the present invention;

FIGS. 7A and 7B illustrate a text message search and call request method for the visually challenged user in a device with a touch screen according to another exemplary embodiment of the present invention;

FIG. 8 illustrates an example of an application selection method for the visually challenged user in a device with a touch screen according to another exemplary embodiment of the present invention;

FIGS. 9A and 9B illustrate an example application selection method for the visually challenged user in a device with a touch screen according to another embodiment of the present invention;

FIG. 10 is a diagram illustrating an example of a numeral input method for the visually challenged user in a device with a touch screen according to a fifth exemplary embodiment of the present invention;

FIG. 11 illustrates an example numeral input method for the visually challenged user in a device with a touch screen according to another exemplary embodiment of the present invention;

FIG. 12 illustrates an example of an application execution method for the visually challenged user in a device with a touch screen according to another embodiment of the present invention;

FIG. 13 illustrates an example application execution method for the visually challenged user in a device with a touch screen according to another exemplary embodiment of the present invention;

FIG. 14 illustrates an example application name mapping method for the visually challenged user in a device with a touch screen according to another embodiment of the present invention; and

FIG. 15 illustrates an example apparatus construction of a device with a touch screen according to the present invention.

### DETAILED DESCRIPTION OF THE PREFERRED EMBODIMENTS

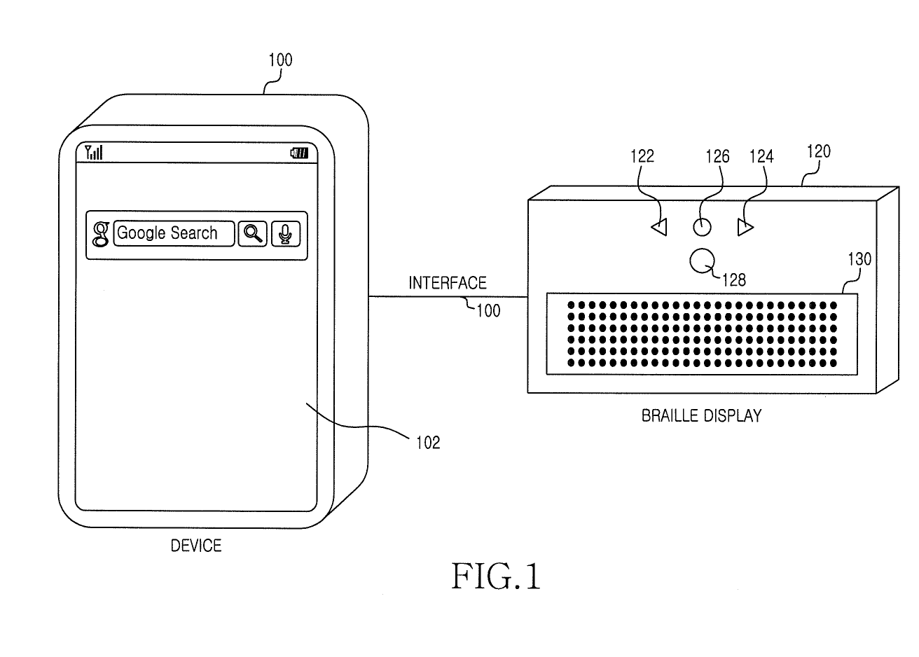

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged touch screen interface devices. Preferred embodiments of the present invention will be described herein below with reference to the accompanying drawings. In the following description, well-known functions or constructions are not described in detail since they would obscure the invention in unnecessary detail. And, terms described below, which are defined considering functions in the present invention, can be different depending on user and operator's intention or practice. Therefore, the terms should be defined on the basis of the disclosure throughout this specification.

Below, example embodiments of the present invention provide an interface provision technology for improving the accessibility of the disabled in a device with a touch screen.

Below, an interface technology according to the present invention is applicable to all types of portable terminals and devices having a touch screen. The portable terminal can be a cellular phone, a Personal Communication System (PCS), a Personal Digital Assistant (PDA), an International Mobile Telecommunication-2000 (IMT-2000) terminal, and the like. Other devices having a touch screen may include a laptop computer, a smart phone, a tablet Personal Computer (PC) and the like.

FIG. 1 illustrates an example device with a touch screen, a Braille display, and an interface according to the present invention. The device 100 with the touch screen 102 may provide a character/numeral size zoom-in/zoom-out function for the visually challenged user, a Text to Speech (TTS) function of converting text data into speech data, a character-Braille conversion Application Programming Interface (API)/protocol support function, and the like. The device 100 with the touch screen 102 transmits Braille data to the Braille display 120 through an interface 110.

The interface 110 provides the interface between the device 100 and the Braille display 120. The interface 110 may be a wired interface or wireless interface. The wired interface can be a Universal Serial Bus (USB), a Serial port, a PS/2 port, an Institute of Electrical and Electronics Engineers (IEEE) 1394, a Universal Asynchronous Receiver/Transmitter (UART) and the like. The wireless interface can be Bluetooth, Wireless Fidelity (WiFi), Radio Frequency (RF), Zigbee and the like.

The Braille display 120 receives Braille data from the device 100 through the interface 110, and outputs the Braille data through a Braille module 130. Further, the Braille display 120 can include at least one of left/right direction keys 122 and 124 for controlling the device 100, an Okay key 126, and a pointing device (e.g., a trackball) 128. For example, the left/right direction keys 122 and 124 can control the device 100 to shift a focused region on the touch screen 102. The Okay key 126 can control the device 100 to transmit a call request signal to a phone number within the focused region on the touch screen 102.

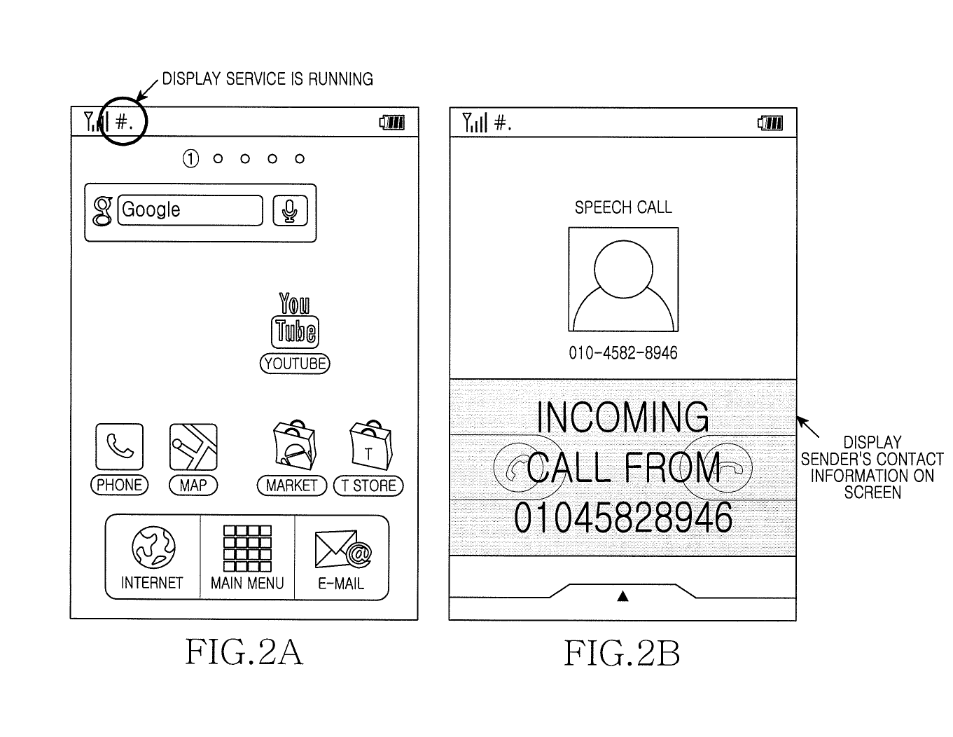

FIG. 2 illustrates an example of an incoming number display method for the visually challenged user in a device with a touch screen according to one embodiment of the present invention. If a call request signal is received in a wait state (FIG. 2A), the device can zoom in and display sender information (i.e., a name and a phone number) (FIG. 2B), thereby allowing a user (e.g., a visually challenged user) to identify the sender information through zoomed-in characters. Also, the device can convert sender information into speech data and output the sender information through a speaker and, in a case where a Braille display is connected with the device through an interface, the device may convert the sender information into Braille data and transmit the Braille data to the Braille display. By this, the visually challenged user can identify the sender information through speech or a Braille point in a relatively easy manner.

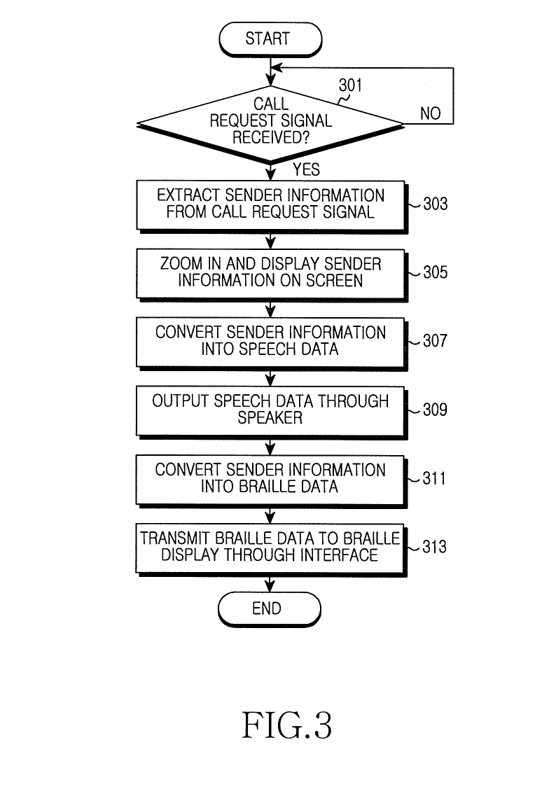

FIG. 3 illustrates an example incoming number display method for the visually challenged user in a device with a touch screen according to another embodiment of the present invention. In step 301, the device determines if a call request signal is received.

In step 301, if it is determined that the call request signal is received, the device extracts sender information from the received call request signal in step 303. Here, the sender information extracted from the received call request signal may include a phone number. Although not illustrated, the device can determine if the extracted phone number is a previously registered number. In a particular case where the extracted phone number is the previously registered number, the device can search a name corresponding to the corresponding phone number in a memory and add the searched name to the sender information.

In step 305, the device zooms in and displays the extracted sender information on a screen. For example, the device can display the extracted sender information on the screen in a default size while simultaneously zooming in and displaying the extracted sender information through a separate popup window. Here, the device can apply a high-contrast screen color scheme to the zoomed-in and displayed sender information. By this, a visually challenged user can identify the sender information through zoomed-in characters in a relatively easy manner.

In step 307, the device converts the extracted sender information into speech data. In step 309, the device outputs the speech data through a speaker. By this, a visually challenged user can identify the sender information through speech in a relatively easy manner.

In step 311, the device converts the extracted sender information into Braille data. In step 313, the device transmits the Braille data to a Braille display through an interface. By this, the visually challenged user can identify the sender information through a Braille point in a relatively easy manner. The device then terminates the algorithm according to the present invention.

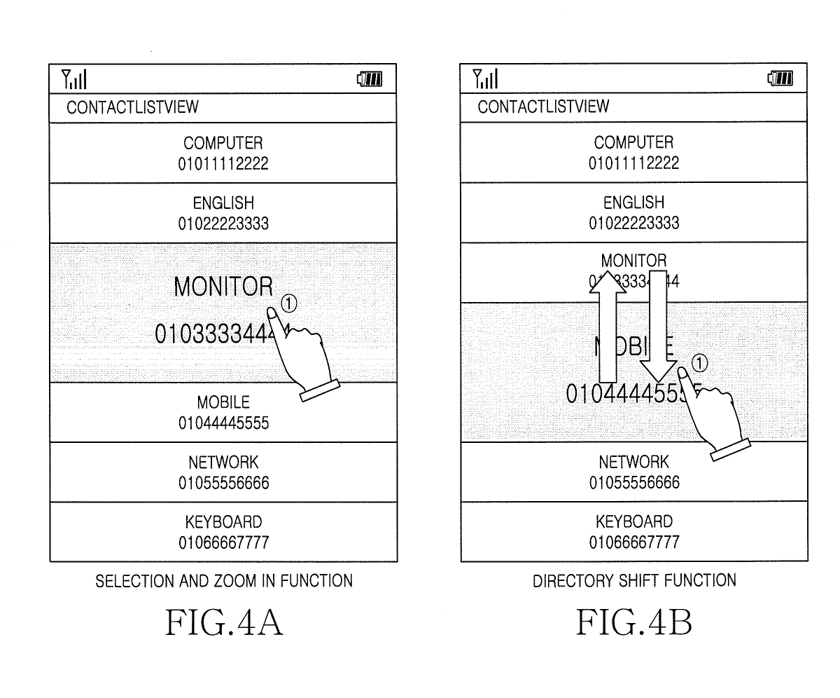

FIG. 4 illustrates an example of a directory search and call request method for the visually challenged user in a device with a touch screen according to another embodiment of the present invention. In a state of displaying a directory composed of a plurality of names and phone numbers on a screen (FIG. 4A), if a touch event occurs, the device focuses a region within screen where the touch event occurs, and zooms in and displays a name and phone number within the focused region. By this, a visually challenged user can identify one name and phone number focused within a directory, through zoomed-in characters. Here, a region focusable within the directory is distinguished based on a region in screen including one name and a phone number corresponding to the name. Also, the device can convert a name and phone number within a focused region into speech data and output the speech data through a speaker and, in a case where a Braille display is connected with the device through an interface, the device may convert the name and phone number within the focused region into Braille data and transmit the Braille data to the Braille display. By this, the visually challenged user can identify one name and phone number focused within a directory through speech or a Braille point. Here, the Braille display may be limited in an amount of Braille data that is displayable at a time such that the Braille display cannot display a name and phone number within a focused region at a time. In this case, the device can group the entire Braille data based on the amount of Braille data that the Braille display can display at a time and, according to the occurrence of a touch event, transmit a first group of Braille data among the entire Braille data to the Braille display through the interface.

Next, if a flicking event takes place in up or down direction, the device shifts the focused region to a higher level in the up or down direction (FIG. 4B). Here, the flicking event means an event of touching a screen and shifting as if flicking the screen in a desired direction.

Although not illustrated, if a flicking event takes place in left or right direction, the device transmits a previous/subsequent group of Braille data to a Braille display through an interface, on a basis of a group of Braille data presently transmitted to the Braille display among the entire Braille data.

Also, although not illustrated, if a multi-scroll event takes place in up or down direction, the device shifts a focused region proportionally to a scroll shift distance in the up or down direction. Here, the multi-scroll event means an event of touching a screen simultaneously in plural positions and shifting the screen in a desired direction.

Also, although not illustrated, if a multi-touch event occurs, the device transmits a call request signal to a phone number within a focused region. Here, the multi-touch event means an event of touching a screen simultaneously in plural positions or an event of touching a screen in series at plural times.

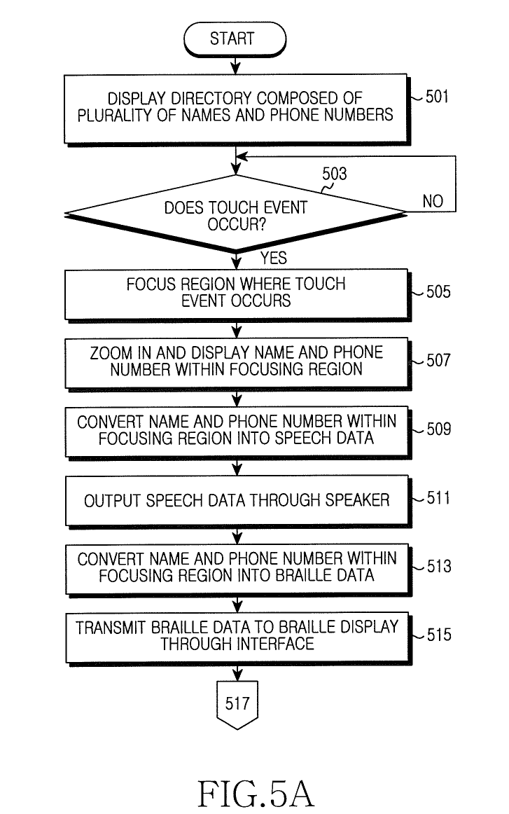

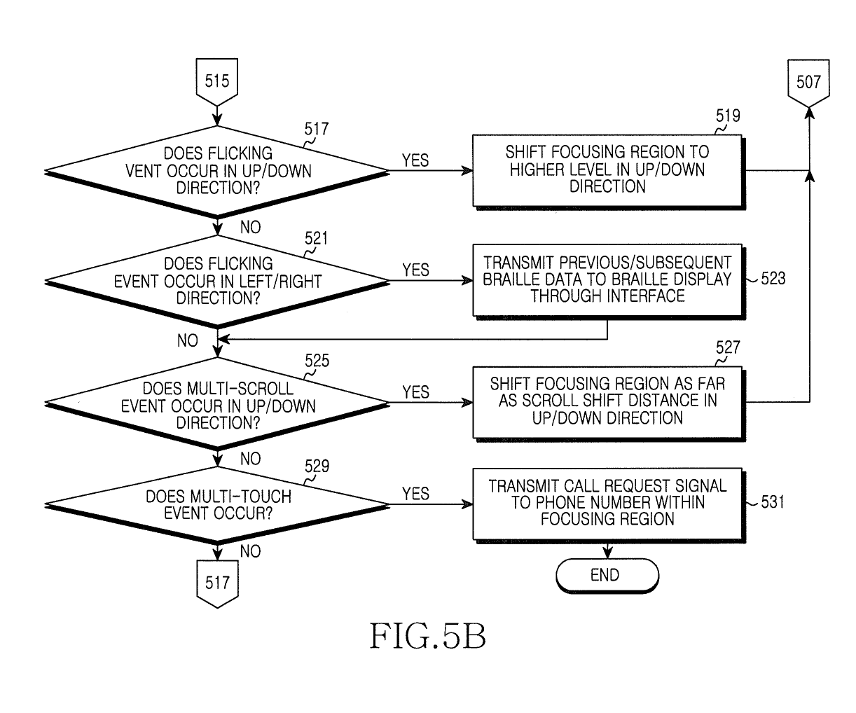

FIGS. 5A and 5B illustrate an example directory search and call request method for the blind in a device with a touch screen according to another embodiment of the present invention. In step 501, according to a user's request, the device displays a directory composed of a plurality of names and phone numbers corresponding to the names on a screen. The directory may include only names and phone numbers to improve the readability of a visually challenged user, and displays a character and a numeral in a large size. Here, a region focusable within the directory is distinguished based on a region within screen including one name and a phone number corresponding to the name.

In step 503, the device determines if a touch event takes place. If it is determined in step 503 that the touch event occurs, the device focuses a region within screen where the touch event occurs in step 505. In step 507, the device zooms in and displays a name and phone number within the focused region. Here, the device can apply a high-contrast screen color scheme to the name and phone number within the focused region. Also, the device can highlight the name and phone number within the focused region. By this, a visually challenged user can identify one name and phone number focused within a directory, through zoomed-in characters. Although not illustrated, zooming in and displaying the name and phone number within the focused region are controllable using a hardware key, such as a volume up/down key.

In step 509, the device converts the name and phone number within the focused region into speech data. In step 511, the device outputs the speech data through a speaker. By this, a visually challenged user can identify one name and phone number focused within a directory through speech.

In step 513, the device converts the name and phone number within the focused region into Braille data. In step 515, the device transmits the Braille data to a Braille display through an interface. By this, the visually challenged user can identify one name and phone number focused within a directory, through a Braille point. Here, the Braille display is limited in an amount of Braille data displayable at a time, such that the Braille display cannot display a name and phone number within a focused region at one time. In this case, the device can group the entire Braille data based on the amount of Braille data that the Braille display can display at a time, and according to the occurrence of a touch event, transmit a first group of Braille data among the entire Braille data to the Braille display through the interface.

After that, in step 517, the device determines if a flicking event occurs in up or down direction. Here, the flicking event means an event of touching a screen and shifting as if flicking the screen in a desired direction. If it is determined in step 517 that the flicking event occurs in the up or down direction, in step 519, the device shifts the focused region to a higher level in the up or down direction and then, returns to step 507, repeatedly performing the subsequent steps. Here, the focused region is shifted to a higher level in a direction of occurrence of the flicking event regardless of a position of the flicking event. In contrast, if it is determined in step 517 that the flicking event does not occur in the up or down direction, the device determines if the flicking event takes place in left or right direction in step 521.

If it is determined in step 521 that the flicking event takes place in the left or right direction, in step 523, the device transmits previous/subsequent Braille data to the Braille display through the interface, and proceeds to step 525. That is, the device transmits a previous/subsequent group of Braille data to the Braille display through the interface according to a direction of occurrence of the flicking event, on a basis of a group of Braille data presently transmitted to the Braille display among the entire Braille data.

In contrast, when it is determined in step 521 that the flicking event does not take place in the left or right direction, the device just proceeds to step 525 and determines if a multi-scroll event occurs in up or down direction. Here, the multi-scroll event means an event of touching a screen simultaneously in plural positions and shifting the screen in a desired direction.

If it is determined in step 525 that the multi-scroll event occurs in the up or down direction, in step 527, the device shifts the focused region as far as a scroll shift distance in the up or down direction and then, returns to step 507, repeatedly performing the subsequent steps. That is, the device detects a real shift distance corresponding to the multi-scroll event taking place in the up or down direction, calculates a scroll shift distance proportional to the detected real shift distance, and shifts the focused region as far as the calculated scroll shift distance in a direction of progress of the multi-scroll event.

In contrast, if it is determined in step 525 that the multi-scroll event does not take place in the up or down direction, in step 529, the device determines if a multi-touch event occurs. Here, the multi-touch event means an event of touching a screen simultaneously in plural positions or an event of touching a screen in series at plural times.

When it is determined in step 529 that the multi-touch event occurs, in step 531, the device transmits a call request signal to the phone number within the focused region and then, terminates the algorithm according to the present invention. Here, the call request signal may be transmitted depending on the occurrence or non-occurrence of the multi-touch event regardless of a position of the multi-touch event. In contrast, if it is determined in step 529 that the multi-touch event does not occur, the device returns to step 517, repeatedly performing the subsequent steps.

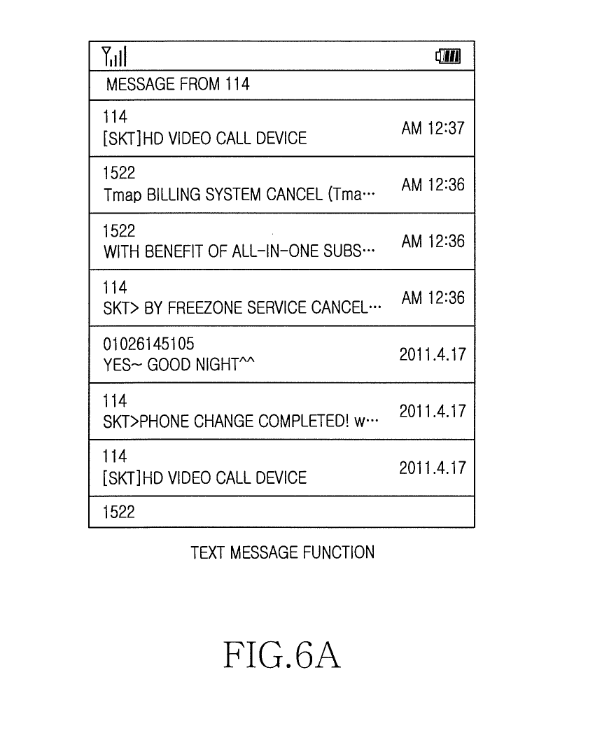

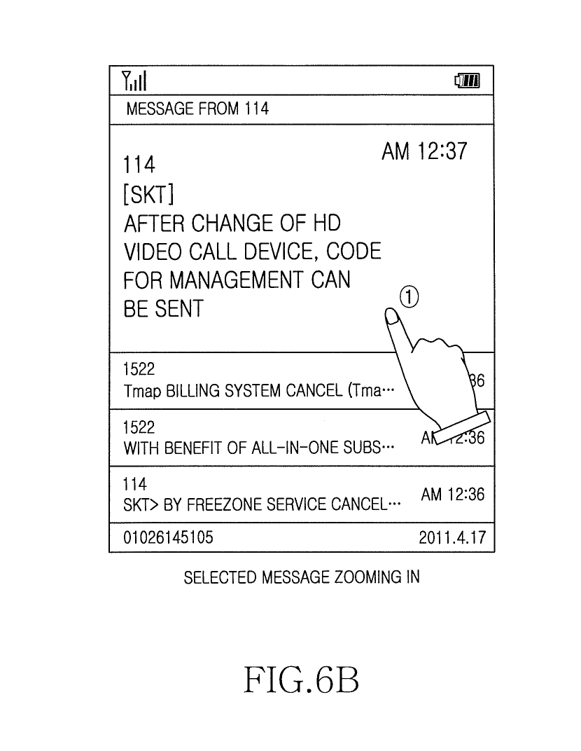

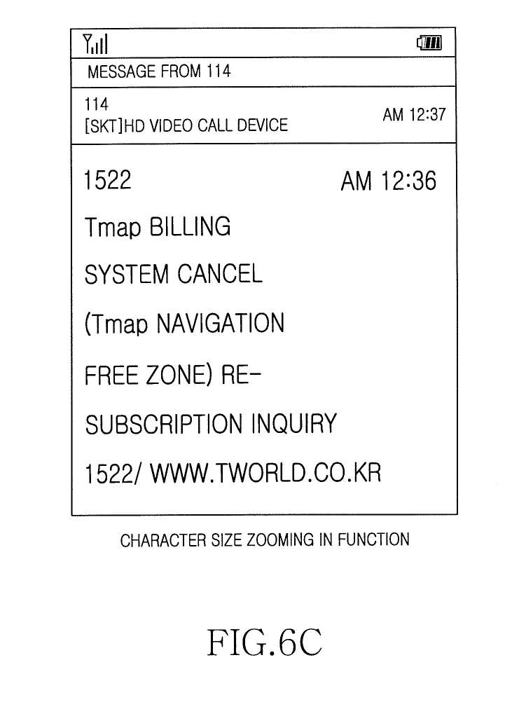

FIG. 6 illustrates an example of a text message search and call request method for the blind in a device with a touch screen according to another embodiment of the present invention. In a state of displaying a text message list including a plurality of names (or phone numbers) and at least a portion of a text message content corresponding to the names on a screen (FIG. 6A), if a touch event occurs, the device focuses a region within screen where the touch event occurs, and zooms in and displays a name (or phone number) and its corresponding entire text message contents within the focused region (FIG. 6B). By this, a user (e.g., the weak blind) can easily identify one name (or phone number) and entire text message contents focused within a text message list, through zoomed-in characters. Here, a region focusable within the text message list is distinguished based on a region within screen including one name (or phone number) and the entire text message contents corresponding to the name. Also, the device can convert a name (or phone number) and its corresponding entire text message contents within a focused region into speech data and output the speech data through a speaker and, in a case where a Braille display is connected with the device through an interface, the device may convert the name (or phone number) and its corresponding entire text message contents within the focused region into Braille data and transmit the Braille data to the Braille display. By this, the blind (e.g., the total blind) can easily identify one name (or phone number) and entire text message contents focused within a text message list, through speech or a Braille point. Here, the Braille display is limited in an amount of Braille data displayable at a time, so the Braille display cannot display a name (or phone number) and the entire text message content within a focused region at one time. In this case, the device can group the entire Braille data based on the amount of Braille data that the Braille display can display at one time and, according to the occurrence of a touch event, the device can transmit a first group of Braille data among the entire Braille data to the Braille display through the interface. Also, zooming in and displaying the name (or phone number) and entire text message contents within the focused region may be controlled using a hardware key (e.g., a volume up/down key) (FIG. 6C).

Although not illustrated, if a flicking event takes place in up or down direction, the device shifts the focused region to a higher level in the up or down direction. Here, the flicking event means an event of touching a screen and shifting as if flicking the screen in a desired direction.

Although not illustrated, if a flicking event takes place in left or right direction, the device transmits a previous/subsequent group of Braille data to a Braille display through an interface, on a basis of a group of Braille data presently transmitted to the Braille display among the entire Braille data.

Also, although not illustrated, if a multi-scroll event takes place in up or down direction, the device shifts a focused region as far as a scroll shift distance in the up or down direction. Here, the multi-scroll event means an event of touching a screen simultaneously in plural positions and shifting the screen in a desired direction.

Also, although not illustrated, if a multi-touch event takes place, the device transmits a call request signal to a name (or phone number) within a focused region. Here, the multi-touch event means an event of touching a screen simultaneously in plural positions or an event of touching a screen in series at plural times.

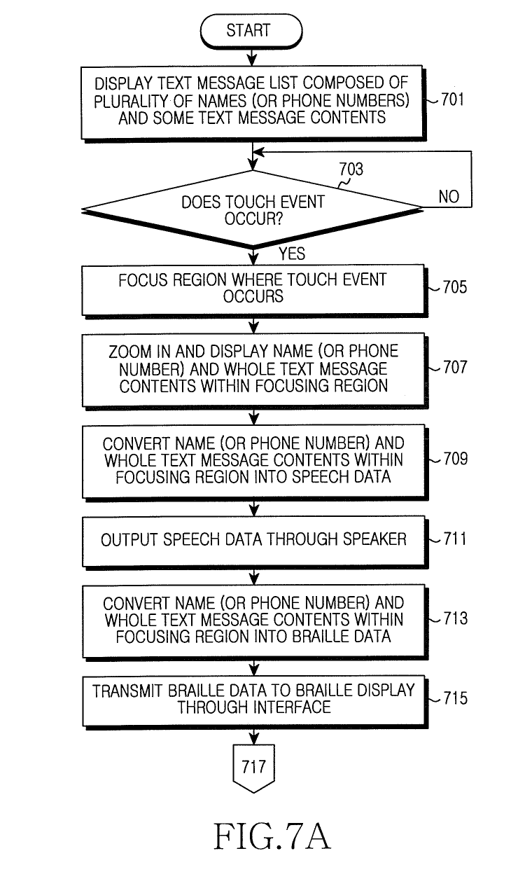

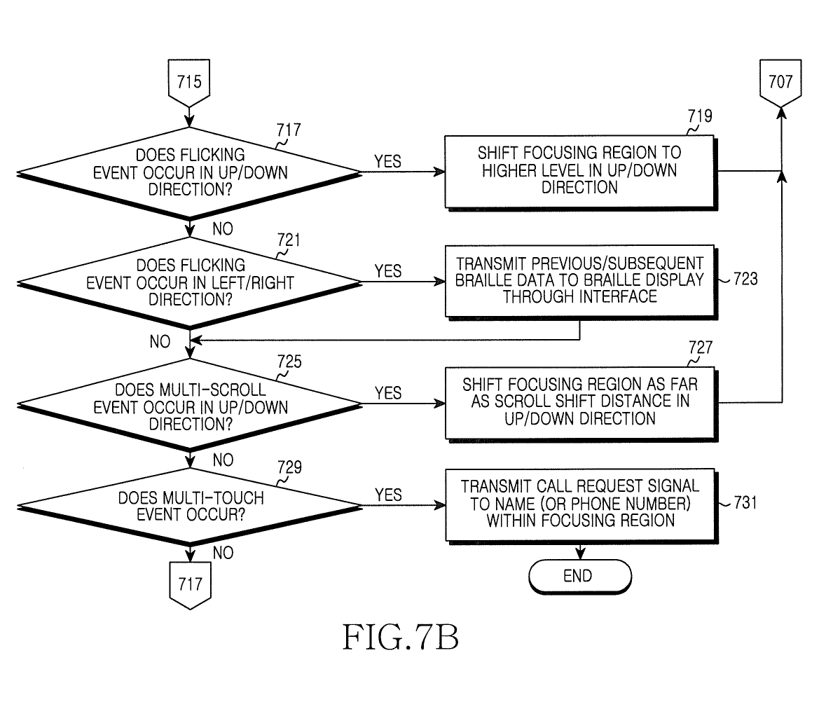

FIGS. 7A and 7B illustrate an example text message search and call request method for the visually challenged user in a device with a touch screen according to another embodiment of the present invention. In step 701, according to a user's request, the device displays a text message list composed of a plurality of names (or phone numbers) and some text message content corresponding to the names on a screen. The text message list may include only names (or phone numbers) and some text message content to improve the readability of a visually challenged user, and displays a character and a numeral in a large size. Here, a region focusable within the text message list is distinguished based on a region within the screen including one name (or phone number) and some text message content corresponding to the name.

In step 703, the device determines if a touch event takes place. If it is determined in step 703 that the touch event occurs, in step 705, the device focuses a region within the screen where the touch event occurs. In step 707, the device zooms in and displays a name (or phone number) and its corresponding entire text message contents within the focused region. Here, the device can apply a high-contrast screen color scheme to the name (or phone number) and entire text message contents within the focused region. Also, the device can highlight the name (or phone number) and entire text message contents within the focused region. By this, a visually challenged user can identify one name (or phone number) and entire text message contents focused within a text message list, through zoomed-in characters in a relatively easy manner. Although not illustrated, zooming in and displaying the name (or phone number) and its corresponding entire text message contents within the focused region are controllable using a hardware key, such as a volume up/down key.

In step 709, the device converts the name (or phone number) and its corresponding entire text message contents in the focused region into speech data. And then, in step 711, the device outputs the speech data through a speaker. By this, a visually challenged user can identify one name (or phone number) and entire text message contents focused within a text message list through speech.

In step 713, the device converts the name (or phone number) and its corresponding entire text message contents within the focused region into Braille data. In step 715, the device transmits the Braille data to a Braille display through an interface. By this, the visually challenged user can identify one name (or phone number) and entire text message contents focused within a text message list, through a Braille point in a relatively easy manner. Here, the Braille display is limited in an amount of Braille data displayable at one time, so the Braille display cannot display a name (or phone number) and entire text message contents within a focused region at one time. In this case, the device can group the entire Braille data based on the amount of Braille data that the Braille display can display at one time and, according to the occurrence of a touch event, transmit a first group of Braille data among the entire Braille data to the Braille display through the interface.

In step 717, the device determines if a flicking event occurs in up or down direction. Here, the flicking event means an event of touching a screen and shifting as if flicking the screen in a desired direction. If it is determined in step 717 that the flicking event occurs in the up or down direction, in step 719, the device shifts the focused region to a higher level in the up or down direction and then, returns to step 707, repeatedly performing the subsequent steps. Here, the focused region is shifted to a higher level in a direction of occurrence of the flicking event regardless of a position of occurrence of the flicking event. In contrast, if it is determined in step 717 that the flicking event does not occur in the up or down direction, in step 721, the device determines if the flicking event takes place in left or right direction.

If it is determined in step 721 that the flicking event takes place in the left or right direction, in step 723, the device transmits previous/subsequent Braille data to the Braille display through the interface, and proceeds to step 725. That is, the device transmits a previous/subsequent group of Braille data to the Braille display through the interface according to a direction of occurrence of the flicking event, on a basis of a group of Braille data presently transmitted to the Braille display among the entire Braille data.

In contrast, if it is determined in step 721 that the flicking event does not take place in the left or right direction, the device just proceeds to step 725 and determines if a multi-scroll event occurs in up or down direction. Here, the multi-scroll event means an event of touching a screen simultaneously in plural positions and shifting the screen in a desired direction.

If it is determined in step 725 that the multi-scroll event occurs in the up or down direction, in step 727, the device shifts the focused region as far as a scroll shift distance in the up or down direction and then, returns to step 707, repeatedly performing the subsequent steps. That is, the device detects a real shift distance corresponding to the multi-scroll event taking place in the up or down direction, calculates a scroll shift distance proportional to the detected real shift distance, and shifts the focused region proportionally to the calculated scroll shift distance in a direction of progress of the multi-scroll event. If it is determined in step 725 that the multi-scroll event does not take place in the up or down direction, in step 729, the device determines if a multi-touch event occurs. Here, the multi-touch event means an event of touching a screen simultaneously in plural positions or an event of touching a screen in series multiple times.

If it is determined in step 729 that the multi-touch event occurs, in step 731, the device transmits a call request signal to the name (or phone number) within the focused region and then, terminates the algorithm according to the present invention. Here, the call request signal is transmitted depending on the occurrence or non-occurrence of the multi-touch event regardless of a position of occurrence of the multi-touch event.

In contrast, If it is determined in step 729 that the multi-touch event does not occur, the device returns to step 717, repeatedly performing the subsequent steps.

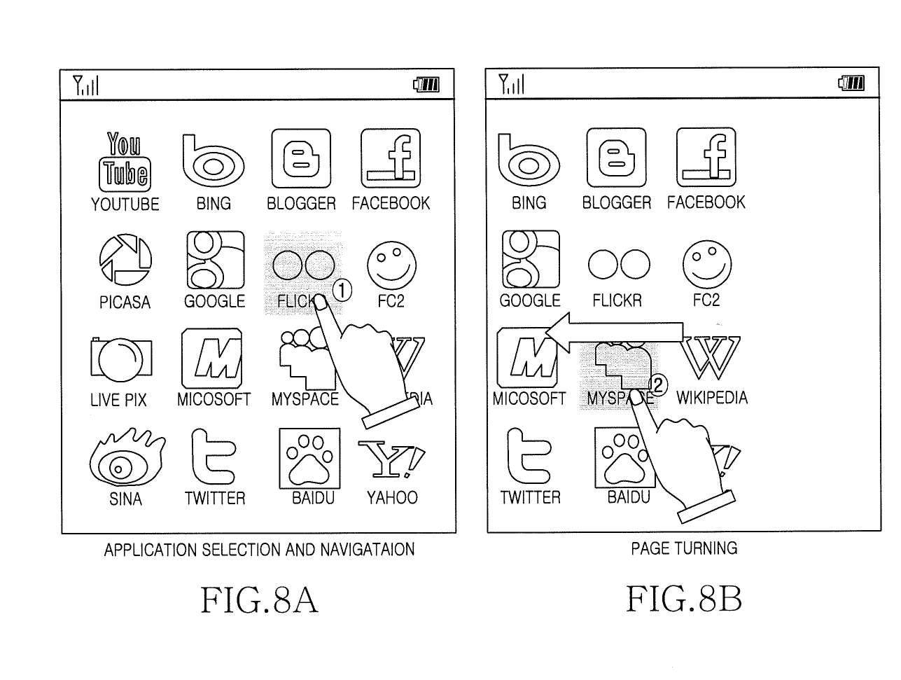

FIG. 8 illustrates an example of an application selection method for the visually challenged user in a device with a touch screen according to another embodiment of the present invention. In a state of displaying an application list composed of a plurality of application names and icons corresponding to the application names on a screen, if a touch event occurs, the device focuses a region within screen where the touch event occurs (FIG. 8A), and zooms in and displays an application name and icon within the focused region at a top or bottom end of the screen. By this, a visually challenged user can identify one application name and icon focused within the application list, through zoomed-in picture and character in a relatively easy manner. Here, a region focusable within the application list is distinguished based on a region within screen including one application name and an icon corresponding to the application name. Also, the device can convert the application name within the focused region into speech data and output the speech data through a speaker and, in a case where a Braille display is connected with the device through an interface, the device may convert the application name within the focused region into Braille data and transmit the Braille data to the Braille display. By this, the visually challenged user can identify one application name focused within an application list, through speech or a Braille point in a relatively easy manner.

After that, if a multi-flicking event occurs in left or right direction, the device turns the screen in the left or right direction (FIG. 8B). Here, the multi-flicking event means an event of touching a screen simultaneously in multiple positions and shifting as if flicking the screen in a desired direction.

Although not illustrated, if a coordinate position of the touch event changes in a state where the touch event is maintained, the device shifts a focused region according to the coordinate position change.

Although not illustrated, if a multi-touch event occurs, the device executes an application within a focused region. Here, the multi-touch event means an event of touching a screen simultaneously in plural positions or an event of touching a screen in series at multiple times.

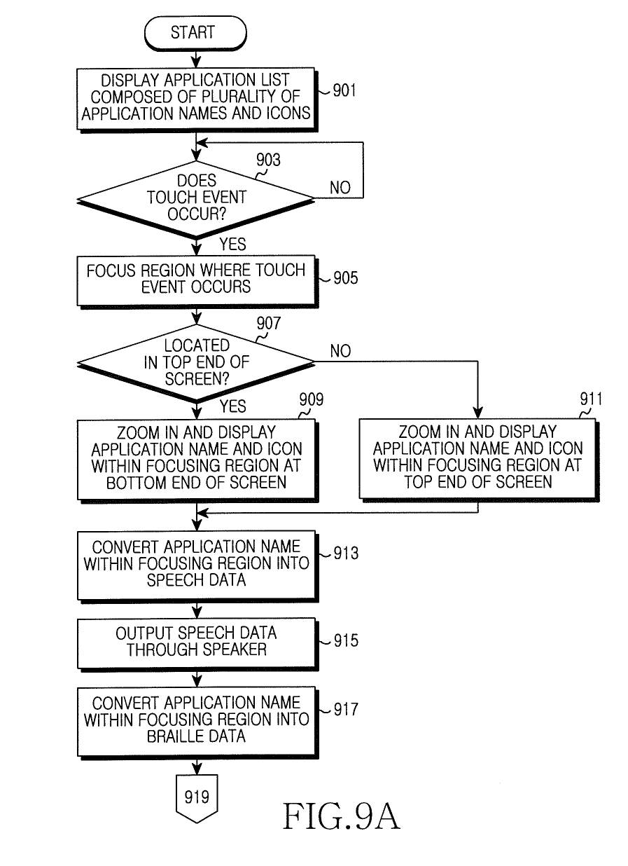

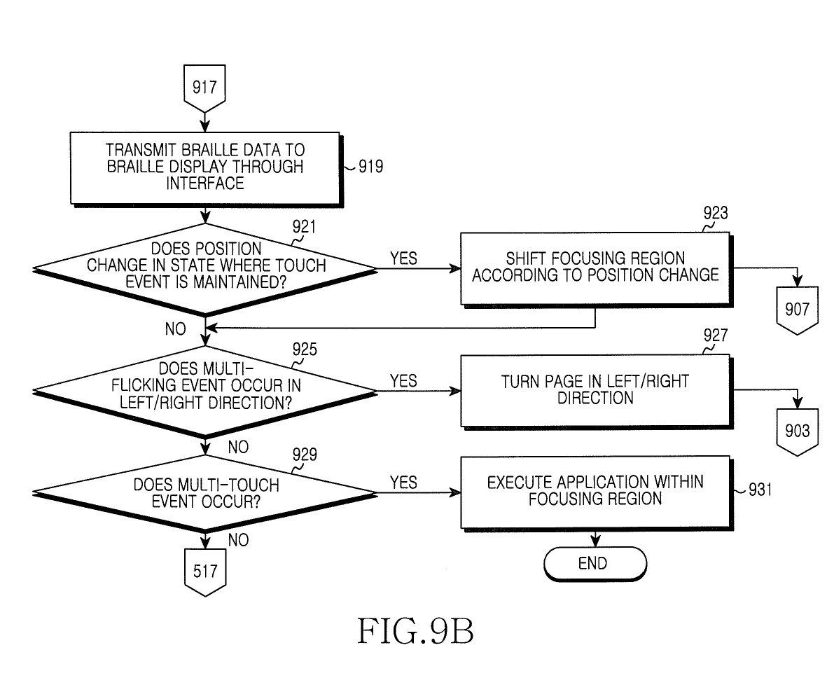

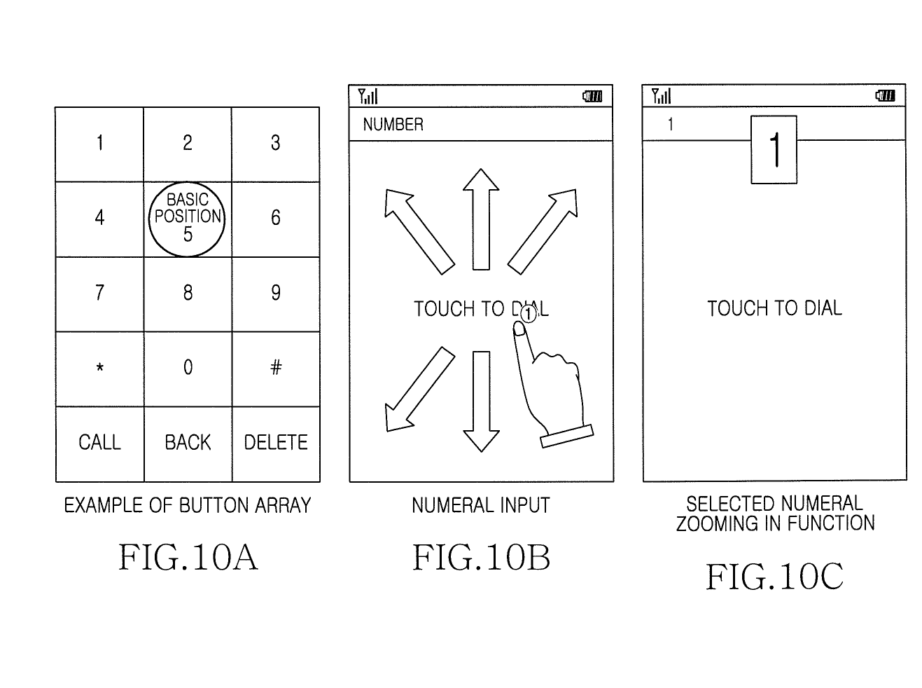

FIGS. 9A and 9B illustrate an example application selection method for the visually challenged user in a device with a touch screen according to another embodiment of the present invention. In step 901, according to a user's request, the device displays an application list composed of a plurality of application names and icons corresponding to the application names on a screen. The application list includes application names and icons to improve the readability of a visually challenged user, and displays a picture, a character, and a numeral in a large size. Here, a region focusable within the application list is distinguished based on a region within screen including one application name and an icon corresponding to the application name

In step 903, the device determines if a touch event occurs. If it is determined in step 903 that the touch event occurs, in step 905, the device focuses a region within screen where the touch event occurs. In step 907, the device determines if the focused region is located in a top end of the screen on a basis of a centerline of the screen.

If it is determined in step 907 that the focused region is located in the top end of the screen on a basis of the screen centerline, in step 909, the device zooms in and displays an application name and icon within the focused region at a bottom end of the screen, and proceeds to step 913. In contrast, if it is determined in step 907 that the focused region is located in the bottom end of the screen on a basis of the screen centerline, in step 911, the device zooms in and displays the application name and icon within the focused region at the top end of the screen, and proceeds to step 913. Here, the device can apply a high-contrast screen color scheme to the application name and icon within the focused region. Also, the device can highlight the application name and icon within the focused region. By this, a visually challenged user can easily identify one application name and icon focused within an application list, through zoomed-in picture and character. Although not illustrated, zooming in and displaying the application name and icon within the focused region are controllable using a hardware key, such as a volume up/down key.

In step 913, the device converts the application name within the focused region into speech data. In step 915, the device outputs the speech data through a speaker. By this, a visually challenged user can easily identify one application name focused within an application list through speech.

Next, in step 917, the device converts the application name within the focused region into Braille data. And then, in step 919, the device transmits the Braille data to a Braille display through an interface. By this, the visually challenged user can identify one application name focused within an application list through a Braille point in a relatively easy manner.

After that, in step 921, the device determines if a coordinate position of the touch event changes in a state where the touch event is maintained.

If it is determined in step 921 that the coordinate position of the touch event changes in the state where the touch event is maintained, in step 923, the device shifts the focused region according to the coordinate position change and then, returns to step 907, repeatedly performing the subsequent steps.

In contrast, if it is determined in step 921 that the coordinate position of the touch event does not change in the state where the touch event is maintained, in step 925, the device determines if a multi-flicking event occurs in left or right direction. Here, the multi-flicking event means an event of touching a screen simultaneously in plural positions and shifting as if flicking the screen in a desired direction.

If it is determined in step 925 that the multi-flicking event occurs in the left or right direction, in step 927, the device turns the screen in the left or right direction. At this time, an application list different from the currently displayed application list can be displayed on the screen according to the screen turning. In contrast, when it is determined in step 925 that the multi-flicking event does not occur in the left or right direction, in step 929, the device determines if a multi-touch event takes place. Here, the multi-touch event means an event for touching a screen simultaneously in multiple positions or an event of touching a screen in series at multiple times.

If it is determined in step 929 that the multi-touch event takes place, in step 931, the device executes an application within the focused region and then terminates the algorithm according to the present invention. Here, the application is executed depending on the occurrence or non-occurrence of the multi-touch event irrespective of a position of the multi-touch event.

In contrast, if it is determined in step 929 that the multi-touch event does not take place, the device returns to step 921, repeatedly performing the subsequent steps.

FIG. 10 illustrates an example of a numeral input method for the visually challenged user in a device with a touch screen according to another embodiment of the present invention. The device divides the remnant region excepting an input window region in a screen into an (n×m) array of regions, and maps numerals, special characters, function names or the like to the divided regions, respectively (FIG. 10A). For example, the device can map numerals of ‘0’ to ‘9’, special characters of ‘*’, ‘#’ and the like, and a delete function, a back function, a call function and the like to the divided regions, respectively. At this time, the device sets, as a reference point (i.e., a basic position), one of the numerals (or special characters) or function names each mapped to the divided regions. For example, the device can set a numeral ‘5’ as the reference point.

After that, if a touch event occurs, the device recognizes a position of occurrence of the touch event as a position of the reference point (e.g., the numeral ‘5’). If a coordinate position of the touch event changes in a state where the touch event is maintained (FIG. 10B), the device changes the touch event occurrence position according to the change of the coordinate position of the touch event based on the (n×m) array of regions, and zooms in and displays a numeral (or special character) or function name mapped to the changed position on the screen through a popup window (FIG. 10C). Also, the device converts the numeral (or special character) or function name mapped to the changed position into speech data and outputs the speech data through a speaker, and converts the numeral (or special character) or function name mapped to the changed position into Braille data and transmits the Braille data to a Braille display through an interface. After that, if a drop event occurs subsequently to the position change, the device inputs a numeral (or special character) mapped to a position of the drop event to an input window, or executes a function (e.g., a call function) mapped to the position of the drop event.

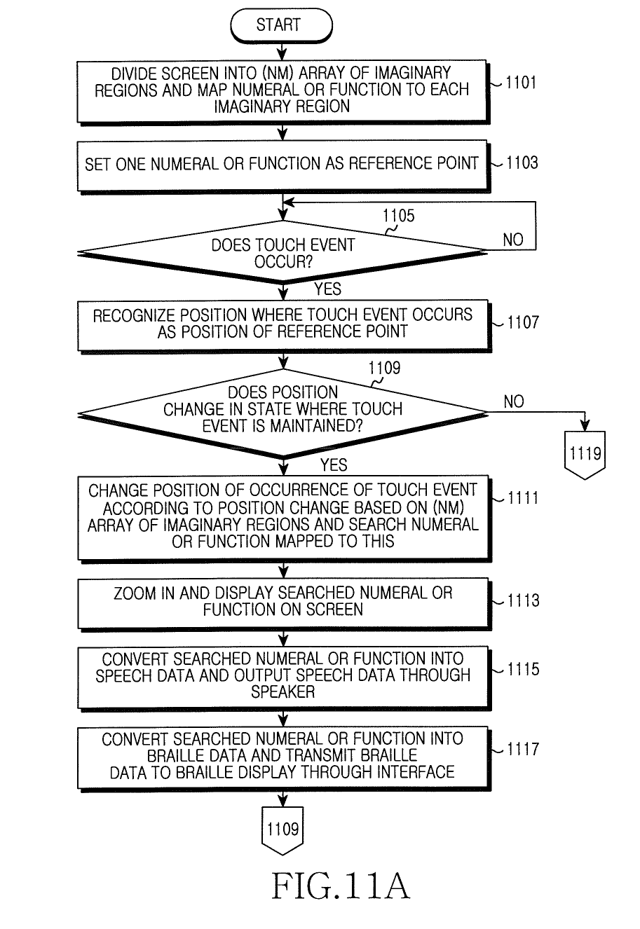

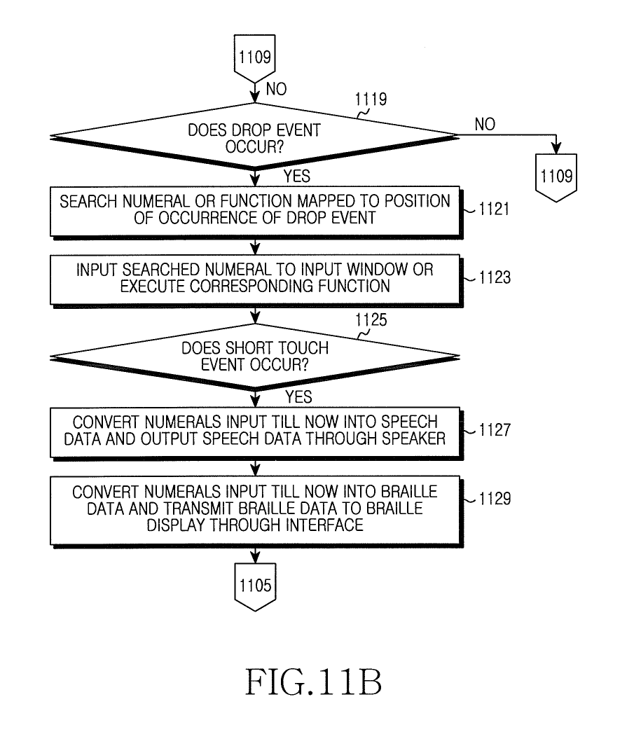

FIG. 11 illustrates an example numeral input method for the visually challenged user in a device with a touch screen according to another embodiment of the present invention. In step 1101, the device divides the remnant region excepting an input window region in a screen into an (n×m) array of regions, and maps numerals, special characters, function names (e.g., an application name) or the like to the divided regions, respectively. For example, the device can map numerals of ‘0’ to ‘9’, special characters of ‘#’ and the like, and a delete function, a back function, a call function and the like to the divided regions, respectively.

After that, in step 1103, the device sets one of the numerals (or special characters) or function names each mapped to the divided regions, as a reference point. For example, the device can set a numeral ‘5’ as the reference point.

After that, in step 1105, the device determines if a touch event takes place.

If it is determined in step 1105 that the touch event occurs, in step 1107, the device recognizes a position of occurrence of the touch event as a position of the reference point (e.g., the numeral ‘5’). And then, in step 1109, the device determines if a coordinate position of the touch event changes in a state where the touch event is maintained.

When it is determined in step 1109 that the coordinate position of the touch event changes in the state where the touch event is maintained, in step 1111, the device changes the touch event occurrence position according to the change of the coordinate position of the touch event based on the (n×m) array of regions, zooms in and displays the numeral (or special character) or function name mapped to the changed position, and proceeds to step 1113.

In step 1113, the device zooms in and displays the searched numeral (or special character) or function name on the screen through a popup window. In step 1115, the device converts the searched numeral (or special character) or function name into speech data and outputs the speech data through a speaker. In step 1117, the device converts the searched numeral (or special character) or function name into Braille data and transmits the Braille data to a Braille display through an interface and then, returns to step 1109, repeatedly performing the subsequent steps.

In contrast, if it is determined in step 1109 that the coordinate position of the touch event does not change in the state where the touch event is maintained, in step 1119, the device determines if a drop event takes place. Here, the drop event means an event of releasing a touch.

If it is determined in step 1119 that the drop event occurs, in step 1121, the device searches a numeral (or special character) or function name mapped to a position of occurrence of the drop event. In step 1123, the device inputs the searched numeral (or special character) to an input window or executes a function (e.g., a call function) corresponding to the searched function name and then, proceeds to step 1125.

After that, in step 1125, the device determines if a short touch event occurs. Here, the short touch event means an event of touching and then releasing without position change. If it is determined in step 1125 that the short touch event occurs, in step 1127, the device converts numerals (or special characters) input to the input window up to now into speech data and outputs the speech data through a speaker. And then, in step 1129, the device converts the numerals (or special characters) input to the input window till now into Braille data and transmits the Braille data to a Braille display through an interface and then, returns to step 1105, repeatedly performing the subsequent steps. In contrast, when it is determined in step 1125 that the short touch event does not occur, the device just returns to step 1105 and repeatedly performs the subsequent steps.

In contrast, when it is determined in step 1119 that the drop event does not occur, the device returns to step 1109 and repeatedly performs the subsequent steps.

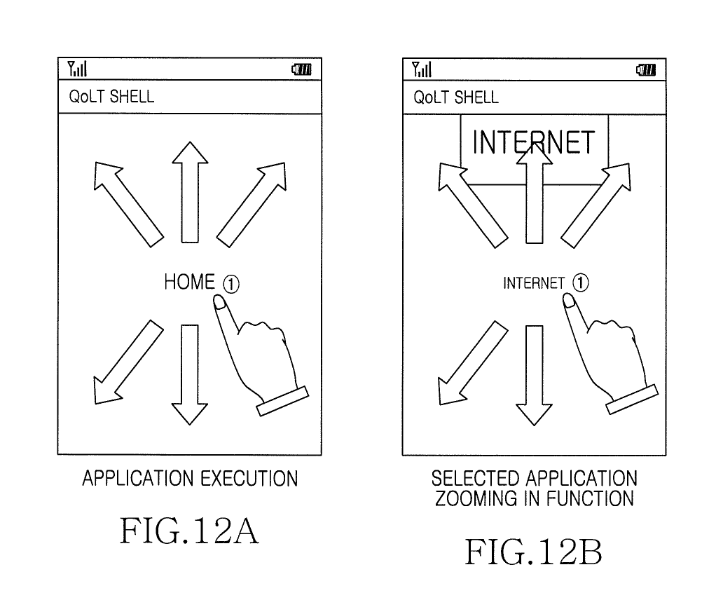

FIG. 12 illustrates an example of an application execution method for the visually challenged user in a device with a touch screen according to another embodiment of the present invention. Although not illustrated, the device divides a screen region into an (n×m) array of regions, and maps an application name to each of the divided regions. At this time, the device sets one of the divided regions as a position region of a reference point.

After that, if a touch event occurs, the device recognizes a position of the touch event as a position of the reference point. If a coordinate position of the touch event changes in a state where the touch event is maintained (FIG. 12A), the device changes the touch event occurrence position according to the change of the coordinate position of the touch event based on the (n×m) array of regions, and zooms in and displays an application name mapped to the changed position through a popup window on a screen (FIG. 12B). Also, the device converts the application name mapped to the changed position into speech data and outputs the speech data through a speaker, and converts the application name mapped to the changed position into Braille data and transmits the Braille data to a Braille display through an interface. After that, if a drop event occurs subsequently to the position change, the device executes an application (e.g., an Internet application) mapped to the position of the drop event.

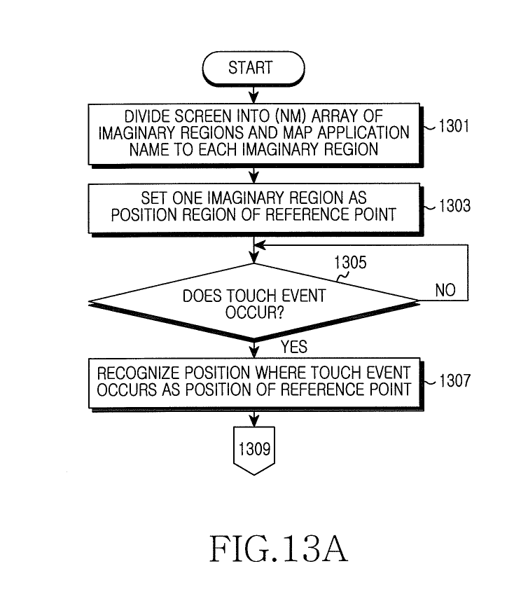

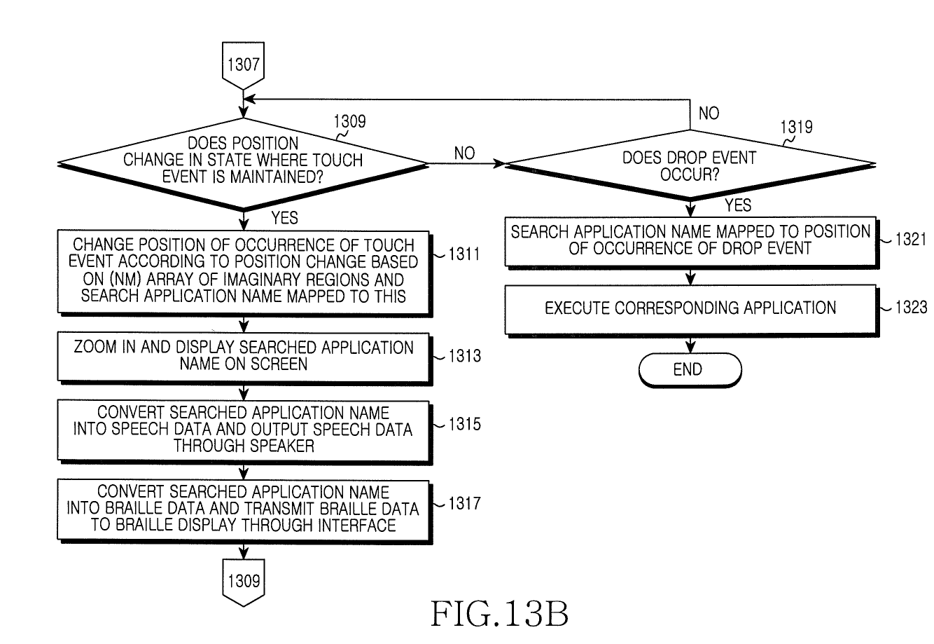

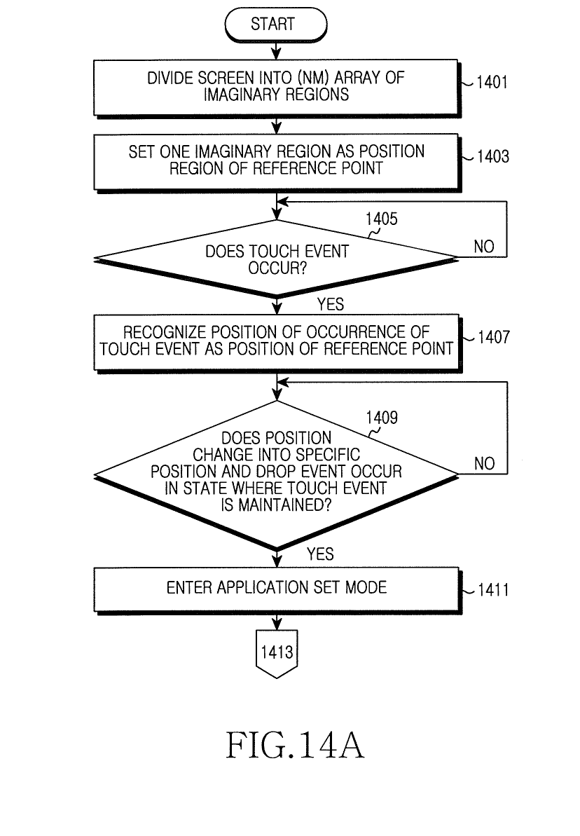

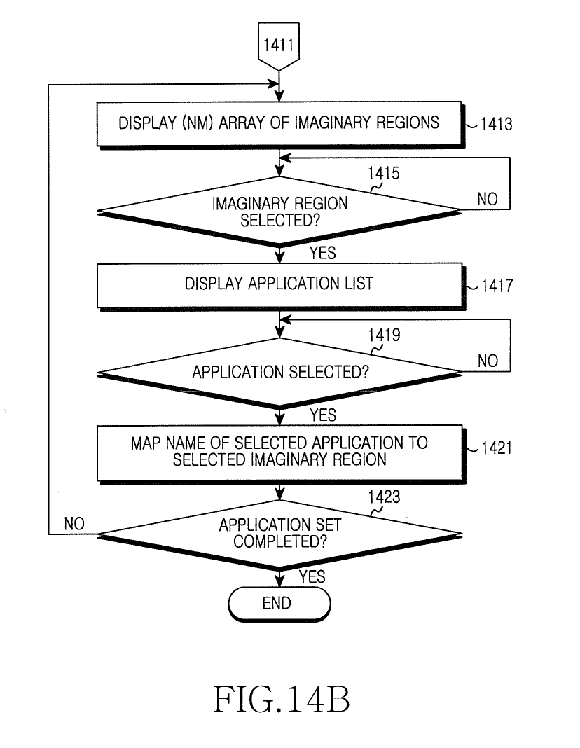

FIG. 13 illustrates an example application execution method for the visually challenged user in a device with a touch screen according to another embodiment of the present invention. In step 1301, the device divides a screen region into an (n×m) array of regions, and maps an application name to each of the divided regions. The above process is described later in detail through FIG. 14.

In step 1303, the device sets one of the divided regions as a position region of a reference point.

In step 1305, the device determines if a touch event takes place.

If it is determined in step 1305 that the touch event occurs, in step 1307, the device recognizes a position of the touch event as a position of the reference point. And then, in step 1309, the device determines if a coordinate position of the touch event changes in a state where the touch event is maintained.

If it is determined in step 1309 that the coordinate position of the touch event changes in the state where the touch event is maintained, in step 1311, the device changes the touch event occurrence position according to the change of the coordinate position of the touch event based on the (n×m) array of regions, searches the application name mapped to the changed position, and proceeds to step 1313.

After that, in step 1313, the device zooms in and displays the searched application name on the screen through a popup window. In step 1315, the device converts the searched application name into speech data and outputs the speech data through a speaker. In step 1317, the device converts the searched application name into Braille data and transmits the Braille data to a Braille display through an interface and then, returns to step 1309, repeatedly performing the subsequent steps.

In contrast, if it is determined in step 1309 that the coordinate position of the touch event does not change in the state where the touch event is maintained, in step 1319, the device determines if a drop event takes place. Here, the drop event means an event of releasing a touch.

If it is determined in step 1319 that the drop event occurs, in step 1321, the device searches an application name mapped to a position of occurrence of the drop event. In step 1323, the device executes an application (e.g., an Internet application) corresponding to the searched application name in an input window and then, terminates the algorithm according to the present invention. In contrast, if it is determined in step 1319 that the drop event does not occur, the device returns to step 1309 and repeatedly performs the subsequent steps.

FIG. 14 illustrates an example application name mapping method for the visually challenged user in a device with a touch screen according to another embodiment of the present invention. In step 1401, the device divides a screen region into an (n×m) array of regions. In step 1403, the device sets one of the divided regions as a position region of a reference point.

After that, in step 1405, the device determines if a touch event takes place. If it is determined in step 1405 that the touch event takes place, in step 1407, the device recognizes a position of occurrence of the touch event as a position of the reference point.

In step 1409, the device determines if, in a state where the touch event is maintained, a coordinate position of the touch event changes into a specific position and in series a drop event occurs. If it is determined in step 1409 that, in the state where the touch event is maintained, the coordinate position of the touch event changes into the specific position and in series the drop event occurs, in step 1411, the device enters an application set mode and, in step 1413, displays an (n×m) array of regions on a screen.

In step 1415, the device determines if one of the displayed regions is selected. Here, the device can determine if one of the displayed regions is selected, by determining if a touch event occurs and, in a state where the touch event is maintained, a coordinate position of the touch event changes and a drop event occurs and then, changing a touch event occurrence position according to the change of the coordinate position of the touch event based on the (n×m) array of regions.

If it is determined in step 1415 that one of the displayed regions is selected, in step 1417, the device displays an application list on the screen.

Next, in step 1419, the device determines if one application is selected from the displayed application list. Here, the device can receive a selection of one application, by displaying the application list on the screen, determine if a touch event occurs, focus a region in which the touch event occurs, and zooming in and displaying an application name within the focused region. Also, the device can convert the application name within the focused region into speech data and output the speech data through a speaker, and convert the application name within the focused region into Braille data, and transmit the Braille data to the Braille display. Also, according to the occurrence or non-occurrence of an up or down flicking event, the device can shift the focused region to a higher level in up or down direction and, according to the occurrence or non-occurrence of a left or right flicking event, the device can transmit previous/subsequent Braille data to the Braille display.

If it is determined in step 1419 that one application is selected from the displayed application list, the device maps a name of the selected application to the selected region in step 1421.

In step 1423, the device determines if it has completed application setting. If it is determined in step 1423 that the device has completed the application setting, the device terminates the algorithm according to the present invention. In contrast, if it is determined in step 1423 that the device has not completed the application setting, the device returns to step 1413 and repeatedly performs the subsequent steps.

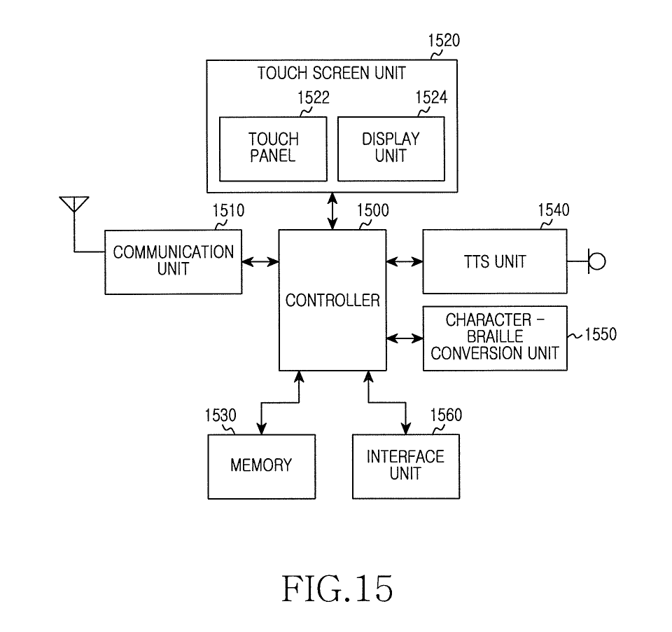

FIG. 15 illustrates an example apparatus of a device with a touch screen according to the present invention. The device includes a controller 1500, a communication unit 1510, a touch screen unit 1520, a memory 1530, a Text to Speech (TTS) unit 1540, a character-Braille conversion unit 1550, and an interface unit 1560. The controller 1500 controls the general operation of the device, and controls and processes a general operation for interface provision for improving the accessibility of the disabled according to the present invention.

The communication unit 1510 performs a function of transmitting/receiving and processing a wireless signal input/output through an antenna. For example, in a transmission mode, the communication unit 1510 performs a function of up-converting a baseband signal to be transmitted into a Radio Frequency (RF) band signal, and transmitting the RF signal through the antenna. In a reception mode, the communication unit 1510 performs a function of down-converting an RF band signal received through the antenna into a baseband signal, and restoring the original data.

The touch screen unit 1520 includes a touch panel 1522 and a display unit 1524. The display unit 1524 displays state information generated during operation of the device, limited number of characters, a large amount of moving pictures and still pictures and the like. The touch panel 1522 is installed in the display unit 1524, and displays various menus on a screen and senses a touch generated on the screen.

The memory 1530 stores a basic program for an operation of the device, setting information and the like.

The TTS unit 1540 converts text data into speech data and outputs the speech data through a speaker.

The character-Braille conversion unit 1550 supports a character-Braille conversion Application Programming Interface (API)/protocol, and converts text data into Braille data and provides the Braille data to the interface unit 1560.

The interface unit 1560 transmits Braille data input from the character-Braille conversion unit 1550, to a Braille display through an interface.

In a description of the present invention, the process of zooming in and displaying, a process of converting into speech data and transmitting through a speaker, a process of converting into Braille data and transmitting to a Braille display and the like may be performed in any sequential order, and it is undoubted that they can be changed in order and can be implemented simultaneously.

On the other hand, it has been described that a device with a touch screen includes a character-Braille conversion unit, for example. Unlike this, in a different method, it is undoubted that a Braille display may include the character-Braille conversion unit. In this case, the device can transmit text data to the Braille display through an interface, and the Braille display can convert the text data into Braille data through the character-Braille conversion unit and output the Braille data through a Braille module.

As described above, example embodiments of the present invention provide an interface for improving the accessibility of the disabled, thereby having an advantage that the visually challenged user can make use of a communication device in a relatively smooth and easy manner.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing an interface in a device with a touch screen, the method comprising:
displaying, on the touch screen, a directory comprising a plurality of names and phone numbers corresponding to the names;
when a touch event takes place, focusing a region within the touch screen where the touch event occurs; and
converting a name and phone number in the focused region into Braille data and transmitting the Braille data to a Braille display through the interface.

2. The method of claim 1, further comprising:
zooming in and displaying on the touch screen, the name and phone number in the focused region; and
converting the name and phone number within the focused region into speech data and outputting the speech data through a speaker.

3. The method of claim 1, further comprising:
when a flicking event occurs in first and second directions, shifting the focused region to a higher level in the first and second directions,
wherein the focused region comprises at least one name and the phone number corresponding to the at least one name.

4. The method of claim 3, wherein the first and second directions comprise up and down directions.

5. The method of claim 1, further comprising:
when a flicking event occurs in first and second directions, transmitting a previous and subsequent group of Braille data to the Braille display through the interface based upon a group of Braille data presently transmitted to the Braille display.

6. The method of claim 5, wherein the first and second directions comprise left and right directions.

7. The method of claim 1, further comprising:
when a multi-scroll event occurs in the first and second directions, shifting the focused region proportionally to the first and second directions.

8. The method of claim 7, wherein the first and second directions comprise up and down directions.

9. The method of claim 1, further comprising:
when a multi-touch event occurs, transmitting a call request signal to the phone number in the focused region.

10. A method for providing an interface in a device with a touch screen, the method comprising:
displaying on the touch screen, a text message list composed of a plurality of phone numbers and at least a portion of a text message content corresponding to the phone numbers;
when a touch event occurs, focusing a region in the touch screen where the touch event occurs; and
converting a phone number and the text message content associated with the phone number in the focusing region into Braille data and transmitting the Braille data to a Braille display through the interface.

11. The method of claim 10, further comprising:
zooming in and displaying the phone number and text message content in the focused region on the touch screen; and
converting the phone number and text message content in the focused region into speech data and outputting the speech data through a speaker.

12. A method for providing an interface in a device with a touch screen, the method comprising:
when a call request signal is received, extracting sender information from the received call request signal; and
converting the extracted sender information into Braille data and transmitting the Braille data to a Braille display through the interface.

13. The method of claim 12, further comprising:
zooming in and displaying the extracted sender information on the touch screen; and
converting the extracted sender information into speech data and outputting the speech data through a speaker.
